(19) United States
(12) Patent Application Publication
(10) Pub. No.: US 2007/0081701 A1
(43) Pub. Date: Apr. 12, 2007

(54) Systems, methods and apparatus for tracking progression and tracking treatment of disease from categorical indices

(75) Inventors: Saad Ahmed Sirohey, Pewaukee, WI (US); Gopal B. Avinash, New Berlin, WI (US); Janet Blumenfeld, Berkeley, CA (US); William Joseph Bridge, Delafield, WI (US); Satoshi Minoshima, Seattle, WA (US)

Correspondence Address: RAMIREZ & SMITH, PO BOX 2843, SPOKANE, WA, 99220-2843, US

(73) Assignee: General Electric Company, Schenectady, NY (US)

(21) Appl. No.: 11/241,570

(22) Filed: Sep. 29, 2005

(51) Int. Cl. G06K 9/00

(52) U.S. Cl. 382/128

(57) ABSTRACT

Systems, methods and apparatus are provided through which in some embodiments, and database of images have categorized levels of severity of a disease or medical condition is generated from human designation of the severity. In some embodiments, the severity of a disease or medical condition is diagnosed by comparison of a patient image to images in the database. In some embodiments, changes in the severity of a disease or medical condition of a patient are measured by comparing a patient image to images in the database.

### RELATED APPLICATION

This application is related to copending U.S. Application Serial Number ______, filed Sep. 29, 2005 entitled “SYSTEMS, METHODS AND APPARATUS FOR DIAGNOSIS OF DISEASE FROM CATEGORICAL INDICES.”

This application is related to copending U.S. Application Serial Number ______, filed Sep. 29, 2005 entitled “SYSTEMS, METHODS AND APPARATUS FOR CREATION OF A DATABASE OF IMAGES FROM CATEGORICAL INDICES.”

### FIELD OF THE INVENTION

This invention relates generally to medical diagnosis, and more particularly to diagnosis of medical conditions from images of a patient.

### BACKGROUND OF THE INVENTION

One form of a medical condition or disease is a neurodegenerative disorder (NDD). NDDs are both difficult to detect at an early stage and hard to quantify in a standardized manner for comparison across different patient populations. Investigators have developed methods to determine statistical deviations from normal patient populations.

These earlier methods include transforming patient images using two types of standardizations, anatomical and intensity. Anatomical standardization transforms the images from the patient's coordinate system to a standardized reference coordinate system. Intensity standardization involves adjusting the patient's images to have equivalent intensity to reference images. The resulting transformed images are compared to a reference database. The database includes age and tracer specific reference data. Most of the resulting analysis takes the form of point-wise or region-wise statistical deviations, typically depicted as Z scores. In some embodiments, the tracer is a radioactive tracer used in nuclear imaging.

A key element of the detection of NDD is the development of age and tracer segregated normal databases. Comparison to these normals can only happen in a standardized domain, e.g. the Talairach domain or the Montreal Neurological Institute (MNI) domain. The MNI defines a standard brain by using a large series of magnetic resonance imaging (MRI) scans on normal controls. The Talairach domain is references a brain that is dissected and photographed for the Talairach and Tournoux atlas. In both the Talairach domain and the MNI domain, data must be mapped to this standard domain using registration techniques. Current methods that use a variation of the above method include tracers NeuroQ®, Statistical Parametric matching (SPM), 3D-sterotactic surface projections (3D-SSP) etc.

Once a comparison has been made, an image representing a statistical deviation of the anatomy is displayed, and a possibly thereafter, a diagnosis of disease is performed In reference to the images. The diagnosis is a very specialized task and can only be performed by highly trained medical image experts. Even these experts can only make a subjective call as to the degree of severity of the disease. Thus, the diagnoses tend to be inconsistent and non-standardized. The diagnoses tend to fall more into the realm of an art than a science.

For the reasons stated above, and for other reasons stated below which will become apparent to those skilled in the art upon reading and understanding the present specification, there is a need in the art for more consistent, formalized and reliable diagnoses of medical conditions and diseases from medical anatomical images.

### BRIEF DESCRIPTION OF THE INVENTION

The above-mentioned shortcomings, disadvantages and problems are addressed herein, which will be understood by reading and studying the following specification.

In one aspect, a method to create a normative categorical index of medical diagnostic images includes accessing image data of at least one anatomical region, the anatomical image data being consistent with an indication of functional information in reference to at least one tracer in the anatomical region at the time of the imaging, determining deviation data from the anatomical image data and from normative standardized anatomical image data based on a criterion of a human, presenting the deviation data for each of the at least one anatomical region, presenting an expected image deviation that is categorized into a degree of severity for each of the at least one anatomical region, receiving an indication of a selection of a severity index, and generating a combined severity score from a plurality of severity indices in reference to a rules-based process.

In another aspect, a method to train a human in normative categorical index of medical diagnostic images includes accessing image data for at least one anatomical region, the anatomical image data being consistent with an indication of functional information in reference to at least one tracer in the anatomical region at the time of the imaging, determining deviation data from the anatomical image data and from normative standardized anatomical image data, presenting the deviation data for each of the at least one anatomical region, presenting an expert-determined image deviation that is categorized into a degree of severity for each of the at least one anatomical region, and guiding the human in selecting an indication of a selection of a severity index based on a visual similarity of a displayed image and the expert-determined image deviation.

In yet another aspect, a method to identify a change in a status of a disease includes accessing at least two longitudinal image data of an anatomical feature, the longitudinal anatomical image data being consistent with an indication of functional information in reference to at least one tracer in the anatomical feature at the time of the imaging, and determining deviation data from each of the longitudinal anatomical image data and from normative standardized anatomical image data based on a criterion of a human, presenting the deviation data for the anatomical feature, presenting an expected image deviation that is categorized into a degree of severity for each of the anatomical feature, receiving an indication of a selection of a severity index for each longitudinal dataset, and generating a combined severity-changes-score from the plurality of severity indices in reference to a rules-based process.

In still another aspect, a method to identify a change in a status of a disease includes accessing longitudinal image data of an anatomical feature, comparing the anatomical longitudinal image data with normative standardized anatomical image data in reference to at least one tracer in the anatomical feature at the time of the imaging, presenting the deviation data for each of the anatomical feature, presenting an expected image deviation that is categorized into a degree of severity for each of the anatomical feature, receiving an indication of a selection of a severity index for each of the longitudinal image data of the anatomical feature, the anatomical longitudinal image data being consistent with an indication of functional information in reference to at least one tracer in the anatomical feature at the time of the imaging, generating a combined severity-changes-score from the plurality of severity indices in reference to a rules-based process, and presenting the combined severity-changes-score.

In a further aspect, a method to create an exemplary knowledge base of diagnostic medical images includes accessing image deviation data of at least one anatomical feature, assigning a categorical degree of severity to each of the image deviation data, and generating a database of the image deviation data and the categorical degree of severity to each of the image deviation data.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of an overview of a system to determine statistical deviations from normal patient populations;

FIG. 2 is a flowchart of a method to determine statistical deviations from normal patient populations;

FIG. 3 is a diagram of a static comparison workflow to guide a reader to a severity index;

FIG. 4 is a flowchart of a method to create a structured and inherent medical diagnosis instructional aid according to an embodiment;

FIG. 5 is a flowchart of a method to according to an embodiment of actions that are performed before the method in FIG. 4;

FIG. 6 is a flowchart of a method to create a structured and inherent medical diagnosis instructional aid according to an embodiment;

FIG. 7 is a flowchart of a method to train a human in normative categorical index of medical diagnostic images according to an embodiment;

FIG. 8 is a flowchart of a method to according to an embodiment of actions that are performed before the method in FIG. 7;

FIG. 9 is a flowchart of a method to create a structured and inherent medical diagnosis instructional aid according to an embodiment;

FIG. 10 is a flowchart of a method to identify a change in a status of a disease according to an embodiment;

FIG. 11 is a flowchart of a method to create an exemplary or normal knowledge base of diagnostic medical images according to an embodiment;

FIG. 12 is a flowchart of a method to generate deviation data according to an embodiment;

FIG. 13 is a flowchart of a method to generate reference diagnostic medical images according to an embodiment;

FIG. 14 is a block diagram of the hardware and operating environment in which different embodiments can be practiced; and

FIG. 15 is a block diagram of an apparatus to generate reference diagnostic medical images according to an embodiment.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from tih scope of the embodiments. The following detailed description is, therefore, not to be taken in a limiting sense.

The detailed description is divided into five sections. In the first section, a system level overview is described. In the second section, embodiments of methods are described. In the third section, the hardware and the operating environment in conjunction with which embodiments may be practiced are described. In the fourth section, embodiments of apparatus are described. In the fifth section, a conclusion of the detailed description is provided.

### System Level Overview

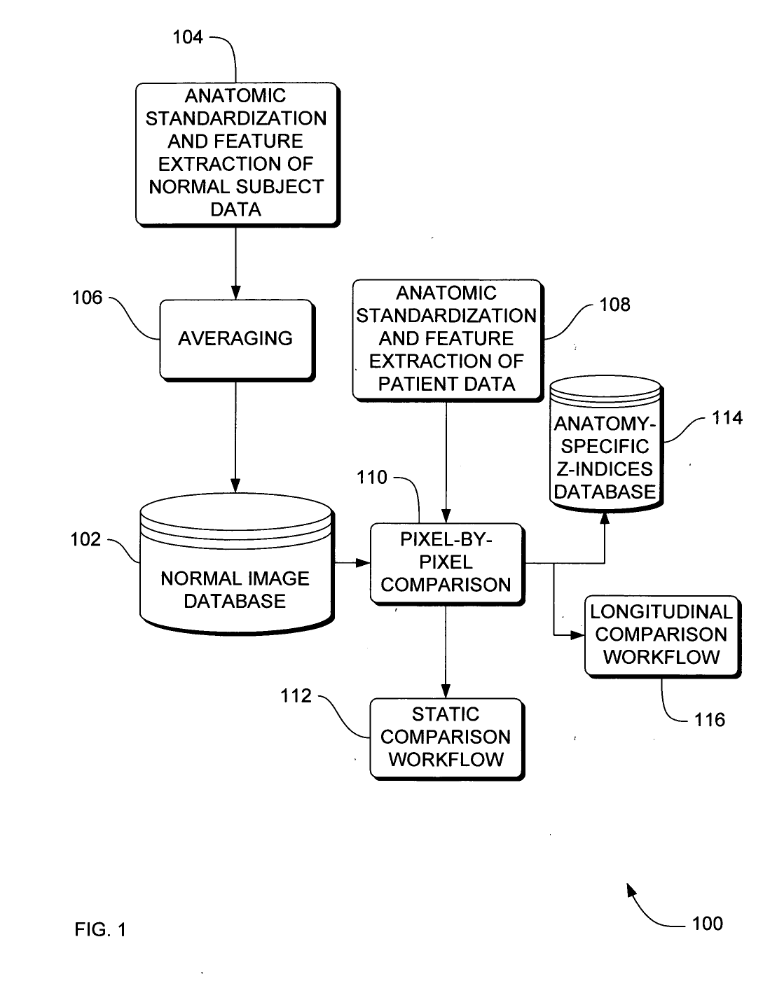

FIG. 1 is a block diagram of an overview of a system to determine statistical deviations from normal patient populations. System 100 solves the need in the art to provide more consistent, formalized and reliable diagnoses of medical conditions and diseases from medical anatomical images.

System 100 includes a normal image database 102. The normal image database 102 includes images of non-diseased anatomical structures. The normal image database 102 provides a baseline for comparison to help identify images of diseased anatomical structures. The comparison baseline provides more consistent, formalized and reliable diagnoses of medical conditions and diseases from medical anatomical images.

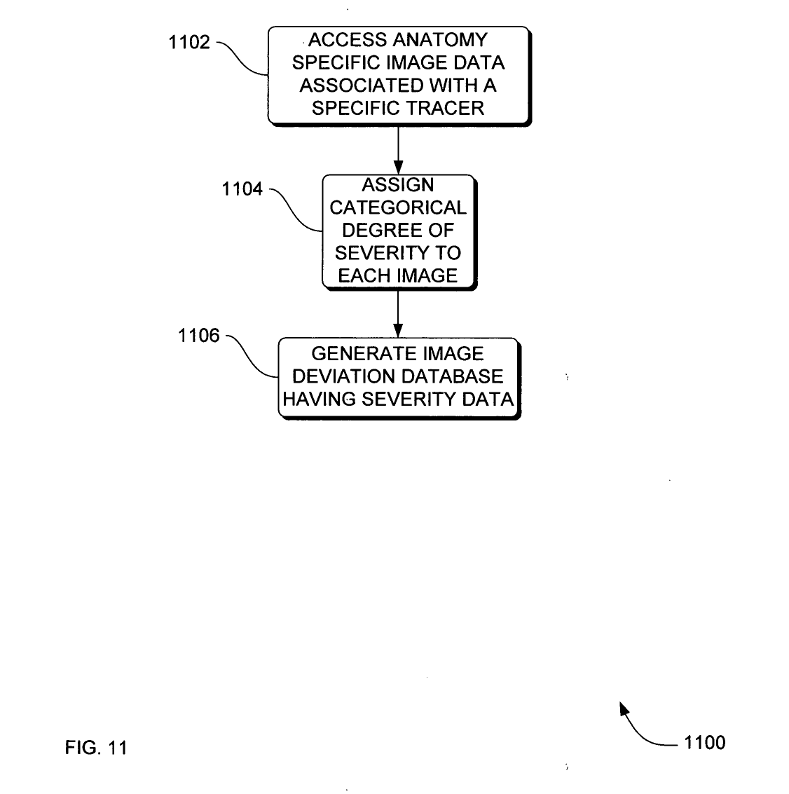

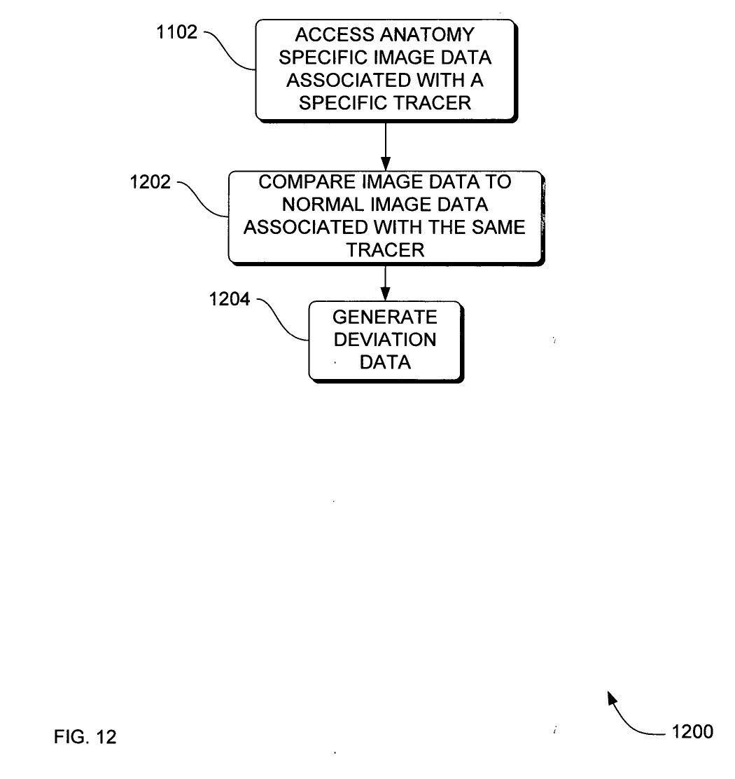

In some embodiments, the normal image database 102 is generated by a component 104 that standardizes normal anatomic images and extracts anatomic features and by another component 106 that averages the extracted anatomic feature images. The averaged anatomic feature images are sufficiently within range of typical non-diseased anatomic features to be considered as normal anatomic features. FIG. 11 and FIG. 12 below shows examples of generating the normal image database 102.

System 100 also includes a component 108 that standardizes anatomic images of a patient and extracts anatomic features of the standardized patient image. The image(s) of extracted anatomic features and the images in the normal image database 102 are encoded in a format that allows for comparison.

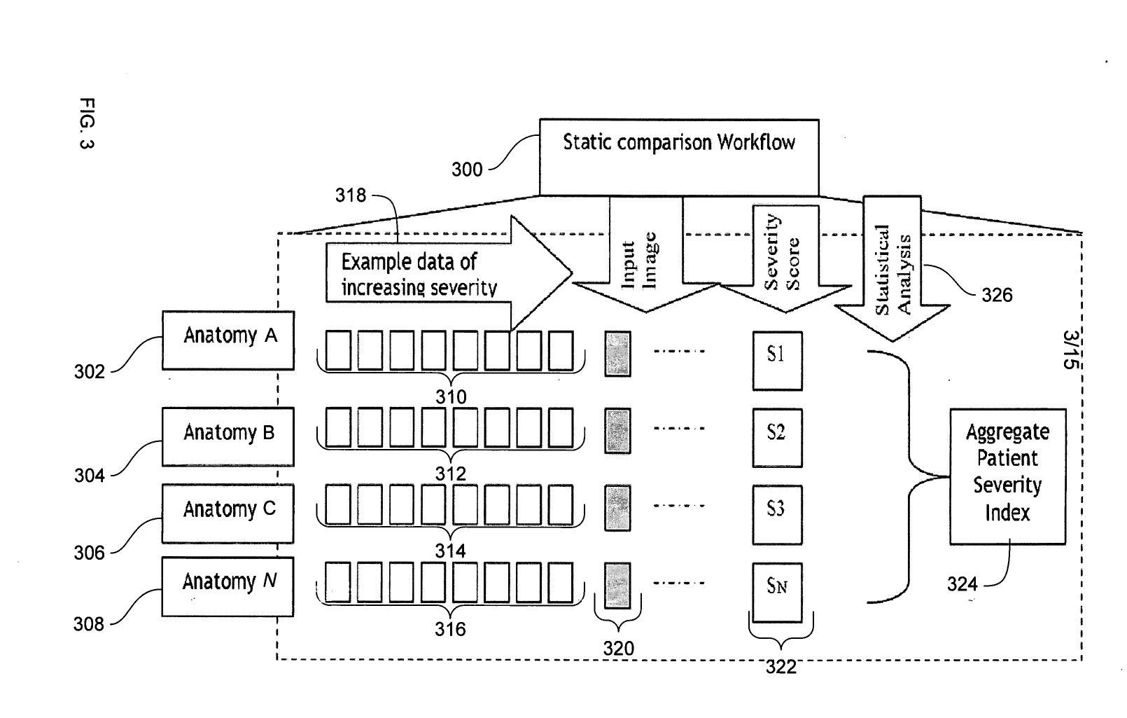

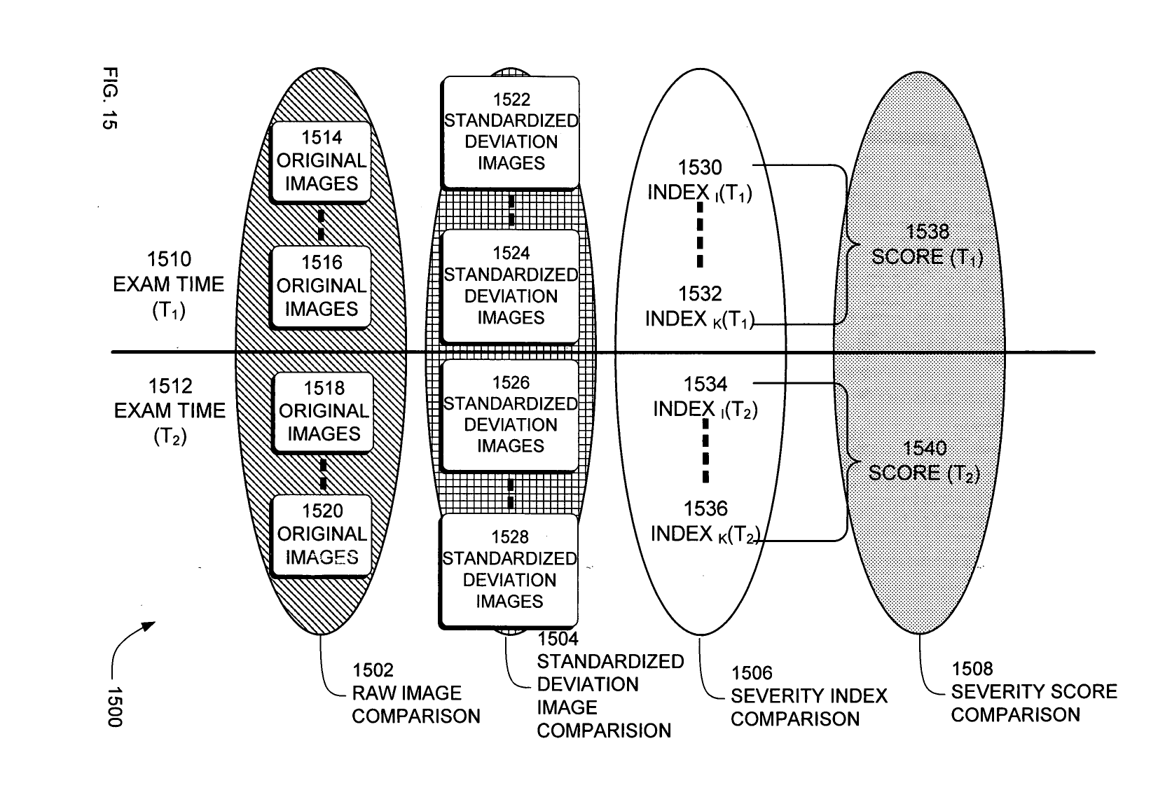

System 100 also includes a component 110 that performs a comparison between the image(s) of extracted anatomic features and the images in the normal image database 102. In some embodiments, a pixel-by-pixel comparison is performed. In some embodiments, the comparison yields a static comparison workflow 112. One embodiment of the static comparison workflow is shown in FIG. 3. In some embodiments, the comparison yields a database 114 of Z-scores that are specific to a particular anatomic feature. In some embodiments, the comparison yields a longitudinal comparison workflow 116. Longitudinal is also known as temporal. A longitudinal comparison compares images over a time interval. Apparatus 1500 in FIG. 15 below describes one related embodiment.

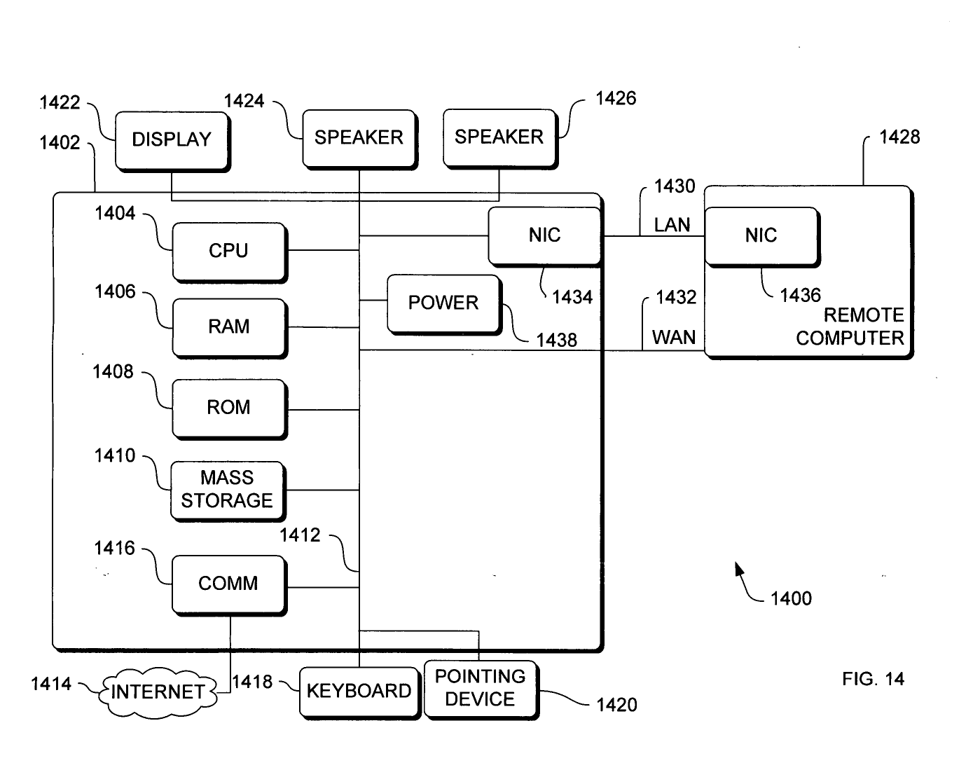

Some embodiments operate in a multi-processing, multi-threaded operating environment on a computer, such as computer 1402 in FIG. 14. While the system 100 is not limited to any particular normal image database 102, component 104 that standardizes normal anatomic images and extracts anatomic features, component 106 that averages the extracted anatomic feature images, component 108 that standardizes anatomic images of a patient and extracts anatomic features of the standardized patient image, component 110 that performs a comparison between the image(s) of extracted anatomic features and the images in the normal image database, static comparison workflow 112, database 114 of Z-scores that are specific to a particular anatomic feature, and longitudinal comparison workflow 116, for sake of clarity a simplified normal image database 102, component 104 that standardizes normal anatomic images and extracts anatomic features, component 106 that averages the extracted anatomic feature images, component 108 that standardizes anatomic images of a patient and extracts anatomic features of the standardized patient image, component 110 that performs a comparison between the image(s) of extracted anatomic features and the images in the normal image database, static comparison workflow 112, database 114 of Z-scores that are specific to a particular anatomic feature, and longitudinal comparison workflow 116 are described.

### Method Embodiments

In the previous section, a system level overview of the operation of an embodiment is described. In this section, the particular methods of such an embodiment are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 200-1300 are performed, by a program executing on, or performed by firmware or hardware that is a part of, a computer, such as computer 1402 in FIG. 14.

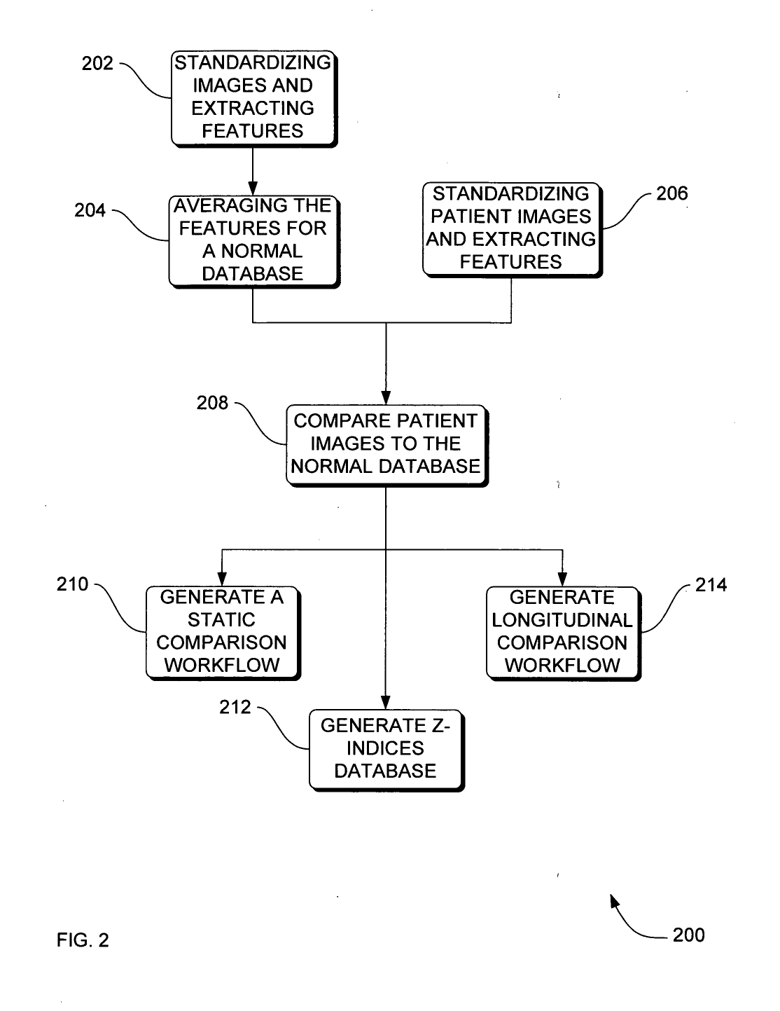

FIG. 2 is a flowchart of a method 200 to determine statistical deviations from normal patient populations. Method 200 includes standardizing 202 normal anatomic images and extracting anatomic features. In some embodiments, standardizing includes mapping to the normal anatomic images to a defined atlas/coordinate system such as a Talairach domain or the Montreal Neurological Institute (MNI) domain. Method 200 also includes averaging 204 the extracted anatomic feature images to yield a database of normal, non-diseased anatomic features.

Method 200 includes standardizing 206 anatomic images of a patient and extracting anatomic features from the standardized patient images. Method 200 also includes comparing 208 the image(s) of the extracted patient anatomic features and the images in the normal image database.

Method 200 also includes generating 210 a static comparison workflow, generating 212 a database 114 of Z-scores that are specific to a particular anatomic feature, and generating 214 a longitudinal comparison workflow. Longitudinal is also known as temporal. A longitudinal comparison compares images over a time interval.

In some embodiments of method 200, after generating 212 the database 114 of Z-scores that are specific to particular anatomic features, method 200 further includes accessing one or more images of one or more specific anatomical features, such as a brain, that are associated with a specific tracer in the database of anatomy-specific Z-indices, and comparing the retrieved brain image data with normative standardized brain image data 102 that is associated with the same tracer, which yields one or more severity scores; and then updating the Z-score database 114 associated with the severity score, optionally editing, refining, and/or updating the severity Z-scores, and presenting exemplary images and associated severity score from the Z-score database 114.

FIG. 3 is a diagram of a static comparison workflow to guide a reader to a severity index. The static comparison workflow 300 is operable for a number of anatomical features, such as anatomical feature “A” 302, anatomical feature “B” 304, anatomical feature “C” 306, and an “n'th” anatomical feature 308. Examples of anatomical features include those of a brain or a heart.

For each anatomical feature, a number of images having variations in the extent of a disease or a condition are provided. For example, for anatomical feature “A” 302, a number of images 310 having variations in the extent of a disease or a condition are provided, for anatomical feature “B” 304, a number of images 312 having variations in the extent of a disease or a condition are provided, for anatomical feature “C” 306, a number of images 314 having variations in the extent of a disease or a condition are provided, and a number of images 316 having variations in the extent of a disease or a condition are provided for anatomical feature “N” 308.

For each anatomical feature, the images of the anatomical features are ordered 318 according to the severity of the disease or condition. For example, for anatomical feature “A” 302, the images 310 are ordered in ascending order from the least extent or amount of the disease or condition, to the highest amount or extent of the disease or condition.

Thereafter, an image 320 is evaluated to determine an extent of disease or condition in the image 320 in comparison to the set of ordered images. For example, the image 320 is evaluated to determine an extent of disease or condition in the image 320 in comparison to the set of ordered images 310 of the anatomical feature “A” 302. In some embodiments, multiple images 320 from the patient for multiple anatomical structures 302, 304, 306 and 308 are evaluated.

The comparison generates a severity index 322 that expresses or represents the extent of disease in the patient image 320. In some embodiments, multiple severity indices 322 are generated that expresses or represents the extent of disease in multiple images 320. In some further embodiments, an aggregate patient severity score 324 is generated using statistical analysis 326.

The static comparison workflow 300 is operable for a number of anatomical features and a number of example data. However, the number of anatomical features and the number of example data is merely one embodiment of the number of anatomical features and the number of example data. In other embodiments, other numbers of anatomical features and other numbers of example data are implemented.

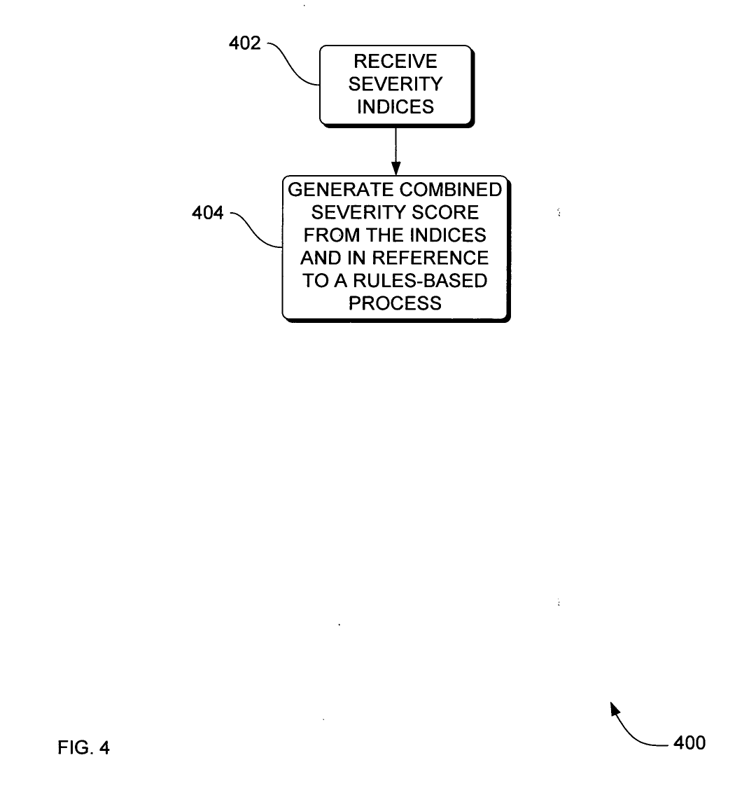

FIG. 4 is a flowchart of a method 400 to create a structured and inherent medical diagnosis instructional aid according to an embodiment. Method 400 solves the need in the art for more consistent, formalized and reliable diagnoses of medical conditions and diseases from medical anatomical images.

Method 400 includes receiving 402 an indication of a severity index of an image of an anatomical feature. The severity index indicates the extent of disease in an anatomical structure in comparison to a non-diseased anatomical structure. Examples of an anatomical structure include a brain and a heart. Designating an expected/expert guided image by a user triggers the severity index for each anatomical location and tracer.

Each of the images having been generated while the anatomical feature included at least one tracer. The images were acquired using any one of a number of conventional imaging techniques, such as magnetic resonance imaging, positron emission tomography, computed tomography, single photon emission-computed tomography, single photon emission computed tomography, ultrasound and optical imaging.

Some embodiments of receiving 402 the severity index includes receiving the selected severity index from or through a graphical user interface, wherein the selected severity index is entered manually into the graphical user interface by a human. In those embodiments, a human develops the severity index and communicates the severity index by entering the severity index into a keyboard of a computer, from which the severity index is received. In some embodiments, the severity index for each of a number of images is received 402.

Method 400 also includes generating 404 a combined severity score from the plurality of severity indices that were received in action 402. The combined severity score is generated in reference to a rules-based process. In some embodiments generating the combined severity score is generated or summed from a plurality of severity indices in reference to a rules-based process. In some embodiments, each anatomical and tracer severity index is aggregated using a rules based method to form a total severity score for the disease state.

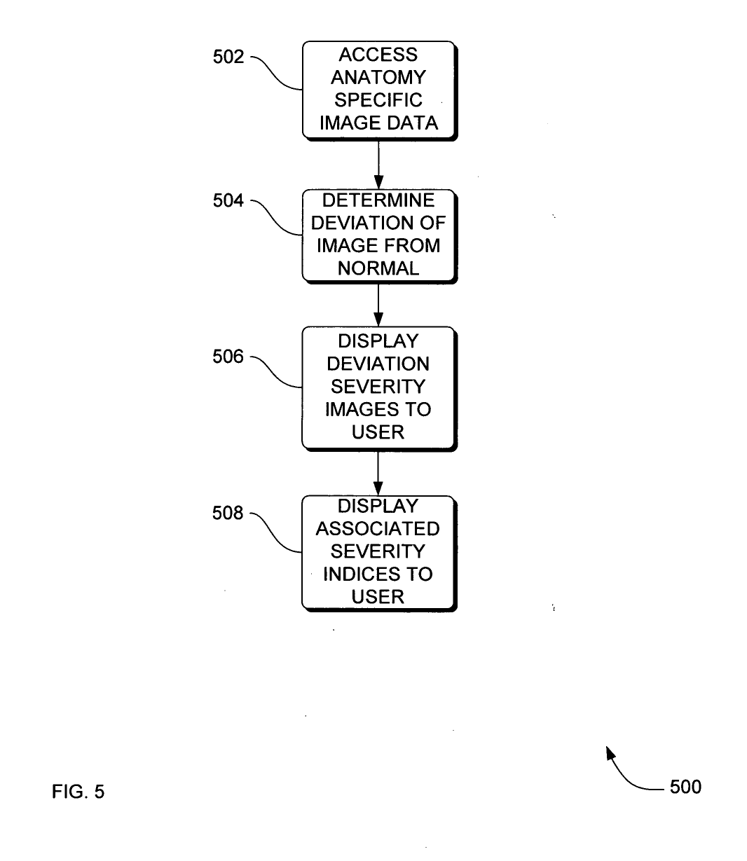

FIG. 5 is a flowchart of a method 500 to according to an embodiment of actions that are performed before the receiving action 402 of method 400 in FIG. 4. Method 500 solves the need in the art for more consistent, formalized and reliable diagnoses of medical conditions and diseases from medical anatomical images.

Method 500 includes accessing 502 image data that is specific to a brain or other anatomical feature. The image data of the brain is consistent with an indication of functional information in reference to at least one tracer in the brain at the time of the imaging. In some embodiments patients are imaged for specific anatomical and functional information using radiotracers or radiopharmaceuticals such as F-18-Deoxyglucose or Fluorodeoxyglucose (FDG), Ceretec®, Trodat®, etc. Each radiotracer provides separate, characteristic information pertaining to function and metabolism. Patient images accessed have been standardized corresponding to relevant tracer and age group.

Method 500 also includes determining 504 deviation data from the brain image data and from normative standardized brain image data based on a human criterion. Examples of the human criteria are age and/or sex of the patient. In some embodiments, determining the deviation data includes comparing the brain image data with normative standardized brain image data in reference to the at least one tracer in the brain at the time of the imaging, as shown in FIG. 3 above. In some embodiments, images are compared pixel-by-pixel to reference images of standardized normal patients.

Thereafter, method 500 includes displaying 506 to the user the deviation severity data for the brain. In some embodiments, the difference images may be in the form of color or grey-scale representations of deviation from normalcy for each anatomical location and tracer.

In other embodiments, the deviation data is presented in other mediums, such as printing on paper.

Subsequently, an expected image deviation is categorized into a degree of severity associated with the brain and is presented 508 to the user. The severity index provides a quantification of the extent of disease, condition or abnormality of the brain.

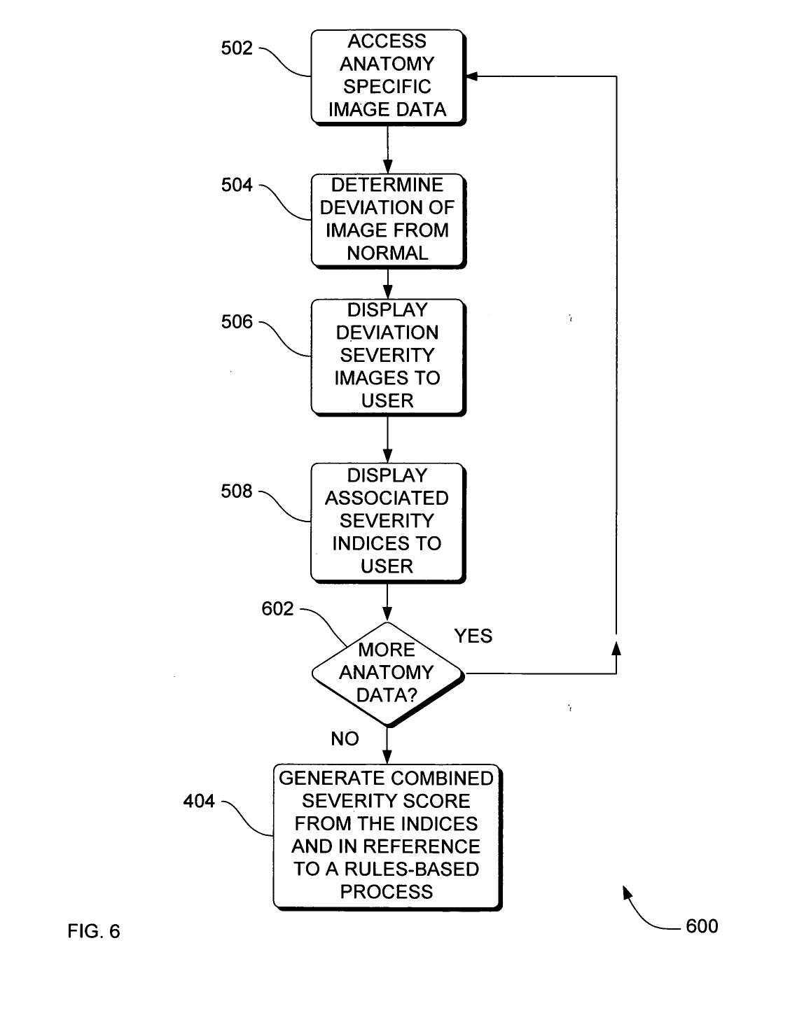

FIG. 6 is a flowchart of a method 600 to create a structured and inherent medical diagnosis instructional aid according to an embodiment. Method 600 solves the need in the art for more consistent, formalized and reliable diagnoses of medical conditions and diseases from medical anatomical images.

In method 600, the accessing action 502, the determining action 504, the presenting actions 506 and 508 and the receiving action 402 are performed a plurality of times before performing the generating action 404. In particular, the accessing action 502, the determining action 504, the presenting actions 506 and 508 and the receiving action 402 are performed until no more 602 anatomy data is available for processing. For example, in FIG. 3, the indices for each anatomical feature “A” 302, anatomical feature “B” 304, anatomical feature “C” 306, and an “n'th” anatomical feature 308 are generated in actions 502-508.

After all iterations of actions 502-508 are completed, the combined severity score is generated 404. The severity score is generated from a greater amount of data, which sometimes is considered or thought to provide a more mathematically reliable combined severity score.

In the embodiment described in method 600 above, the indices and score for each anatomical feature are generated in series. However, other embodiments of method 600 generate the indices and the score for each anatomical feature in parallel.

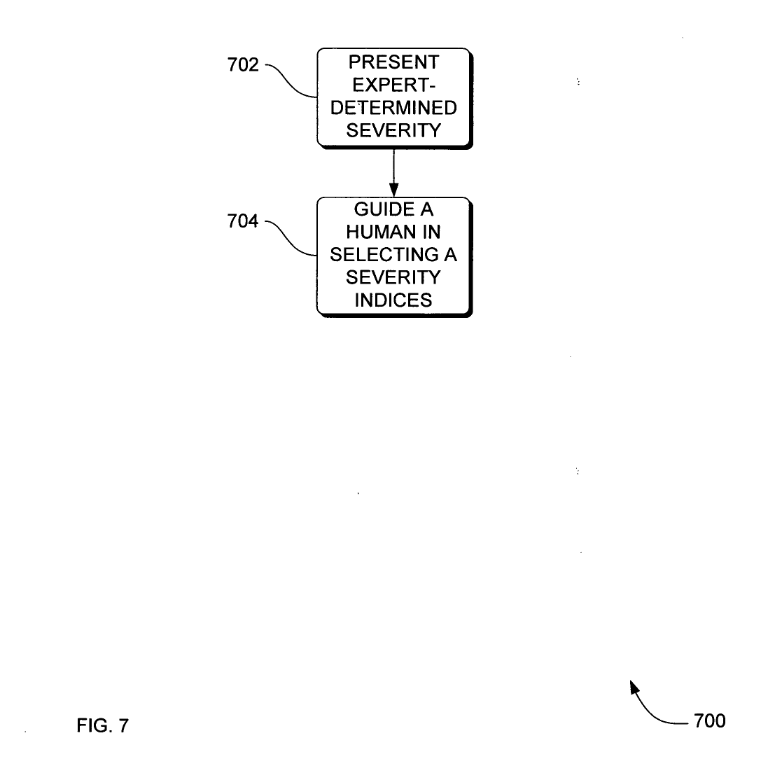

FIG. 7 is a flowchart of a method 700 to train a human in normative categorical index of medical diagnostic images according to an embodiment. Method 700 solves the need in the art for more consistent, formalized and reliable diagnoses of medical conditions and diseases from medical anatomical images.

Method 700 includes presenting 702 to a user, an expert-determined expected image deviation for a brain with category of a degree of severity. The severity index provides a quantification of the extent of disease, condition or abnormality of the brain.

Thereafter, method 700 includes guiding 704 a human in selecting an indication of a selection of a severity index based on a visual similarity of a displayed image and the expert-determined image deviation. The images guide the user to make a severity assessment for the patient.

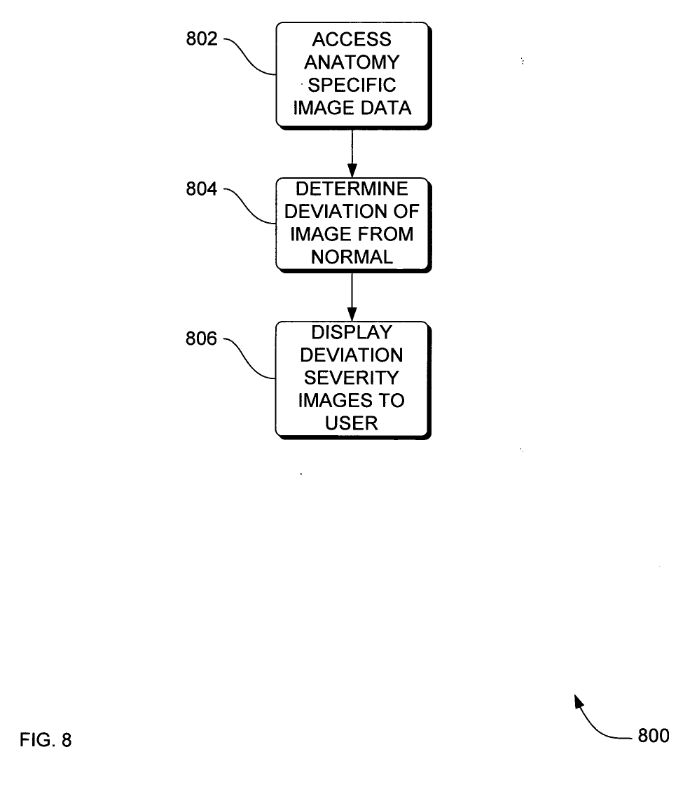

FIG. 8 is a flowchart of a method 800 to according to an embodiment of actions that are performed before the method 700 in FIG. 7. Method 800 solves the need in the art for more consistent, formalized and reliable diagnoses of medical conditions and diseases from medical anatomical images.

Method 800 includes accessing 802 image data that is specific to a brain or other anatomical feature. The image data of the brain is consistent with an indication of functional information in reference to at least one tracer in the brain at the time of the imaging.

Method 800 also includes determining 804 deviation data from the brain image data and from normative standardized brain image data based on a human criterion. Example of the human criteria are age and/or sex of the patient. In some embodiments, determining the deviation data includes comparing the brain image data with normative standardized brain image data in reference to the at least one tracer in the brain at the time of the imaging, as shown in FIG. 3 above.

Thereafter, method 800 includes displaying 806 to the user the deviation severity data for the brain. In other embodiments, the deviation data is presented in other mediums, such as printing on paper.

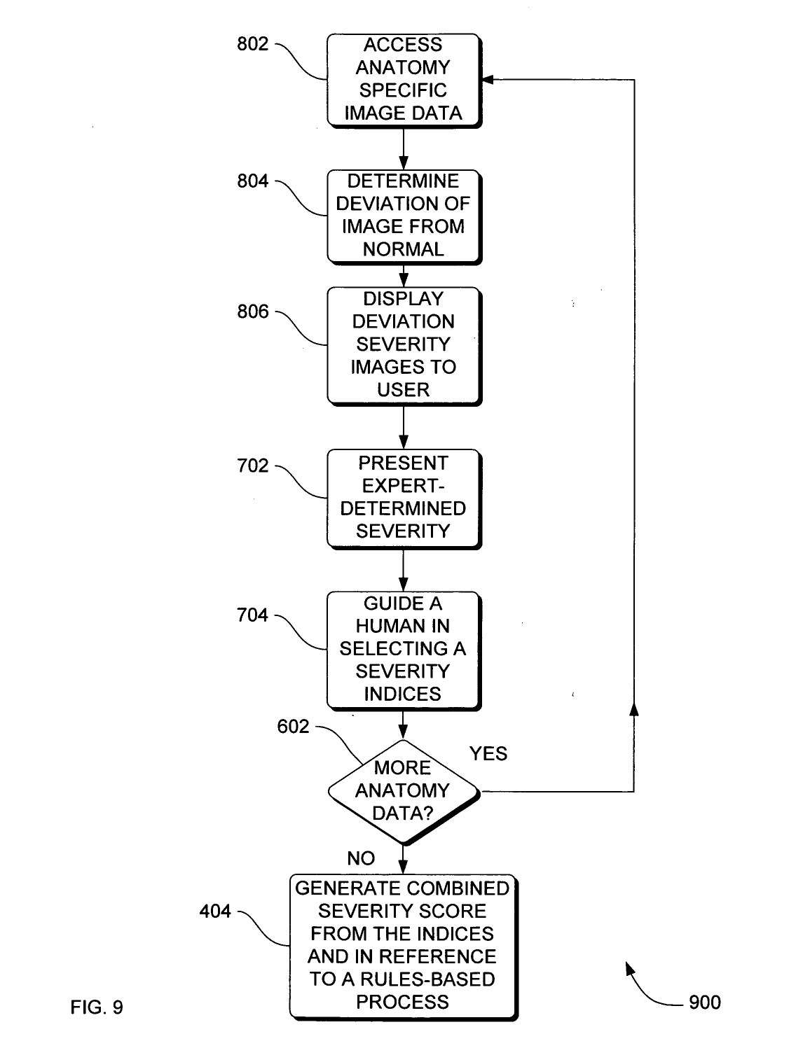

FIG. 9 is a flowchart of a method 900 to create a structured and inherent medical diagnosis instructional aid according to an embodiment. Method 900 solves the need in the art for more consistent, formalized and reliable diagnoses of medical conditions and diseases from medical anatomical images.

In method 900, the accessing action 802, the determining action 804, the presenting actions 806 and 702 and the guiding action 704 are performed a plurality of times before generating a combined severity score.

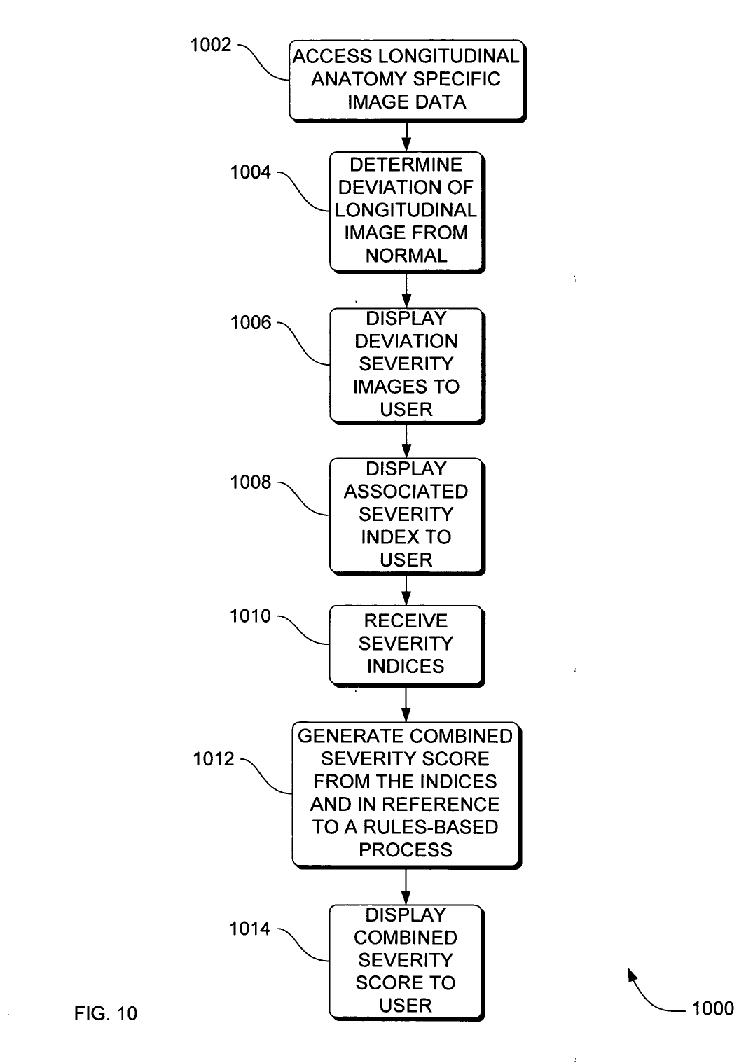

FIG. 10 is a flowchart of a method 1000 to identify a change in a status of a disease according to an embodiment. Method 1000 solves the need in the art for more consistent, formalized and reliable diagnoses of medical conditions and diseases from medical anatomical images.

Some embodiments of method 1000 include accessing 1002 longitudinal image data that is specific to at least two anatomical features. The longitudinal anatomical image data indicates functional information in reference to at least one tracer in the anatomical feature at the time of imaging. Examples of anatomical features include a brain or a heart. Longitudinal is also known as temporal. A longitudinal comparison compares images over a time interval.

The images were acquired using any one of a number of conventional imaging techniques, such as magnetic resonance imaging, positron emission tomography, computed tomography, single photon emission computed tomography, ultrasound and optical imaging. Patients are imaged for specific anatomical and functional information using tracers at two different time instances. Each tracer provides separate, characteristic information pertaining to function and metabolism. Patient images accessed at each time instance have been standardized corresponding to relevant tracer and age group.

Thereafter, some embodiments of method 1000 include determining 1004 deviation data from each of the longitudinal anatomical image data and from normative standardized anatomical image data based on a criterion of a human. Examples of the human criteria are age and/or sex of the patient. Some embodiments of determining 1004 the deviation data include comparing the anatomical longitudinal image data with normative standardized anatomical image data in reference to the tracer in the anatomical feature at the time of the imaging. In some embodiments, images of each time instance in the longitudinal analysis are compared pixel by pixel to reference images of standardized normal patients.

Subsequently, method 1000 includes presenting to a user the 1006 deviation severity data from the anatomical features. In some embodiments, the deviation data is in the form of difference images that show the difference between the longitudinal anatomical image and the normative standardized anatomical image. Furthermore the difference images can be in the form of color or grey-scale representations of deviation from normalcy for each anatomical location and tracer and for every time instance in the longitudinal analysis.

Thereafter, method 1000 includes presenting to the user 1008 an expected image deviation that is categorized into a degree of severity associated with the anatomical feature. In some embodiments, the user matches the expected image, which triggers the severity index for each anatomical location and tracer at all instances of the longitudinal analysis.

Subsequently, method 1000 includes receiving 1010 from the user an indication of a selection of a severity index for each longitudinal dataset. Some embodiments of receiving 1010 an indication of the severity index include receiving the selected severity index from a graphical user interface, wherein the selected severity index is entered manually into the graphical user interface by a human. In some embodiments, the expected images are displayed with associated levels of severity to a user. The images guide the user to make a severity assessment for the current patient in each of the temporal time instances of the longitudinal analysis.

Subsequently, method 1000 includes generating 1012 a combined severity-changes-score from the plurality of severity indices. In some embodiments, the combined severity-changes-score is generated in reference to a rules-based process and then the combined severity-changes-score is presented to the user. Some embodiments of generating a combined severity score include summing the plurality of severity indices in reference to a rules-based process. In some embodiments, each anatomical and tracer severity index is individually or comparatively (difference of instances of longitudinal study) aggregated using a rules based method to form a total changed severity score for the disease state at all instances of the longitudinal study. Both methods of change determination can be implemented, one that can be more indicative of anatomical location changes and the other which provides an overall disease state severity score change.

In some embodiments of method 1000, accessing 1002 the longitudinal image data, determining 1004 the deviation, presenting 1006 and 1008 and receiving 1010 the severity indices are performed a number of times before generating 1012 and displaying 1014 the combined severity-changes-score. In some embodiments, a number of severity indices are displayed for the specific anatomy over a time period, which shows progress, or lack of progress of treatment of the disease over the time period.

FIG. 11 is a flowchart of a method 1100 to create an exemplary or normal knowledge base of diagnostic medical images according to an embodiment. Method 1100 solves the need in the art for more consistent, formalized and reliable diagnoses of medical conditions and diseases from medical anatomical images.

Method 1100 includes accessing 1102 one or more images of one or more specific anatomical features that are associated with a specific tracer. Deviation data is data that represents deviation or differences from an image that is considered to be representative of normal anatomical conditions or non-diseased anatomy. In some embodiments, the deviation image data is derived before performance of method 1100 by comparing images from normal subject database and suspected disease image database including data pertaining to all severity of a disease, such as described in method 1200 in FIG. 12 below.

In some embodiments, an image from which the image deviation data was derived was created or generated without use of a tracer in the patient. In other embodiments, an image from which the image deviation data was derived was created or generated with a use of a tracer in the patient.

Method 1100 also includes assigning 1104 a categorical degree of severity to each of the image of deviation data consistent with an indication of functional information pertaining to all severity of disease. The categorical degree of severity describes the extent of the severity of disease or medical condition within a certain range. In some embodiments, the categorical degree of severity describes a measure of a deviation of an image from an exemplary image. Examples of degree of disease or condition are described in FIG. 3, in reference to the ascending order 318 of images where each image in the ascending order 318 represents one categorical degree of severity of disease or condition.

Thereafter, method 1100 includes generating 1106 a database or knowledgebase of the image deviation data and the categorical degree of severity to each of the image deviation data. In one example, the normal image database 102 in FIG. 1 is generated or updated with the image deviation data and associated with the categorical degree of severity of the image deviation data.

Some embodiments of method 1100 also include refining or updating exemplary severity deviation image. More specifically, the exemplary severity deviation database is refined by aggregating newly assigned severity deviation image with existing severity image/images, or updated by introducing a new category of severity deviation image or by removing an existing category.

FIG. 12 is a flowchart of a method 1200 to generate deviation data according to an embodiment. Method 1200 can be performed before method 1100 above to generate the deviation data required in method 1100. Method 1200 solves the need in the art for more consistent, formalized and reliable diagnoses of medical conditions and diseases from medical anatomical images.

Method 1200 includes accessing 1102 one or more images of one or more specific anatomical features, such as a brain, that are associated with a specific tracer.

Method 1200 also includes comparing 1202 the brain image data with normative standardized brain image data that is associated with the same tracer, as shown in FIG. 3 above, yielding a deviation between the images that represent suspect areas of disease in the brain with images in a database. In some embodiments, the comparing 1202 is performed in reference to a tracer, or in other embodiments, not in reference to a tracer.

Method 1200 also includes generating 1204 the deviation image data from the comparison.

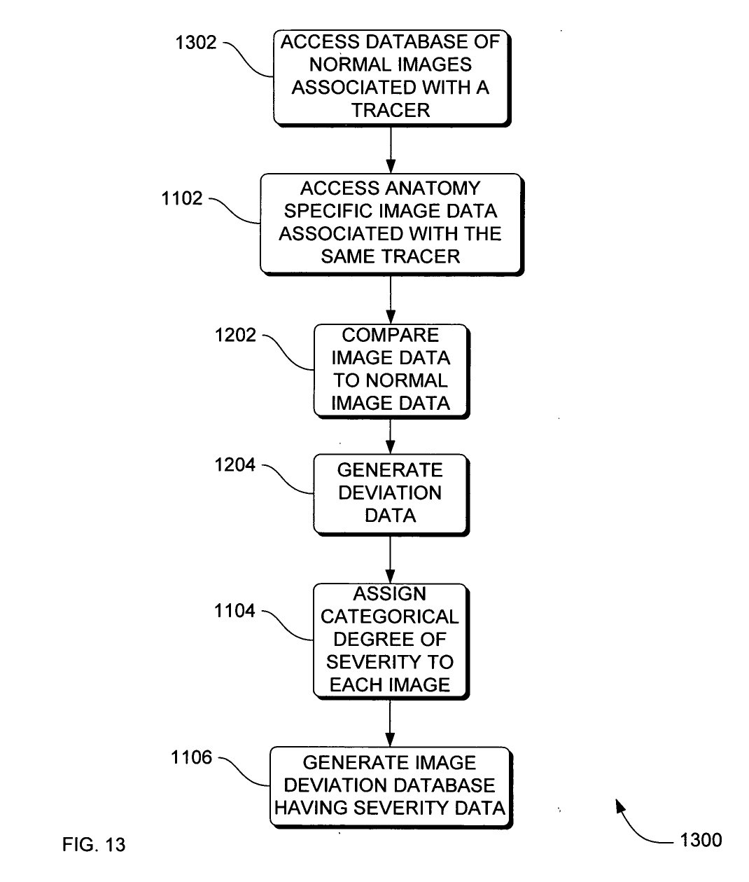

FIG. 13 is a flowchart of a method 1300 to generate reference diagnostic medical images according to an embodiment. Method 1300 solves the need in the art for more consistent, formalized and reliable diagnoses of medical conditions and diseases from medical anatomical images.

Method 1300 includes accessing 1302 a database; the database containing a plurality of images of a normal pre-clinical anatomical feature that pertain to a tracer. In some embodiments, action 1302 includes creating a normative database using normal subjects through the use of functional information pertaining to a tracer.

Method 1300 thereafter includes accessing 502 images that represent suspect areas of disease in the anatomical feature, comparing 1202 the images that represent suspect areas of disease in the anatomical feature with images in the database, thus yielding a deviation between the images that represent suspect areas of disease in the anatomical feature with images in the database. In some embodiments, accessing the image includes accessing a database of suspect images that are consistent with an indication of functional information potentially corresponding to a variety of severity of the disease through the use of the tracer.

Then a plurality of images representing the deviation are generated 1204 for each anatomical feature, a categorical degree of severity is assigned 1104 to each of the plurality of images representing the deviation, and a database of the plurality of images representing the deviation and the categorical degree of severity of each of the plurality of images representing the deviation is generated 1106.

In some embodiments of method 1300, the exemplary severity deviation database is be refined by aggregating newly assigned severity deviation image with existing severity image/images, or updated by introducing a new category of severity deviation image or by removing an existing category.

In some embodiments, methods 200-1300 are implemented as a computer data signal embodied in a carrier wave, that represents a sequence of instructions which, when executed by a processor, such as processor 1404 in FIG. 14, cause the processor to perform the respective method. In other embodiments, methods 200-1300 are implemented as a computer-accessible medium having executable instructions capable of directing a processor, such as processor 1404 in FIG. 14, to perform the respective method. In varying embodiments, the medium is a magnetic medium, an electronic medium, or an optical medium.

More specifically, in a computer-readable program embodiment, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in computer 1402 in FIG. 14, or on at least as many computers as there are components.

### Hardware and Operating Environment

FIG. 14 is a block diagram of the hardware and operating environment 1400 in which different embodiments can be practiced. The description of FIG. 14 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

Computer 1402 includes a processor 1404, commercially available from Intel, Motorola, Cyrix and others. Computer 1402 also includes random-access memory (RAM) 1406, read-only memory (ROM) 1408, and one or more mass storage devices 1410, and a system bus 1412, that operatively couples various system components to the processing unit 1404. The memory 1406, 1408, and mass storage devices, 1410, are types of computer-accessible media. Mass storage devices 1410 are more specifically types of nonvolatile computer-accessible media and can include one or more hard disk drives, floppy disk drives, optical disk drives, and tape cartridge drives. The processor 1404 executes computer programs stored on the computer-accessible media.

Computer 1402 can be communicatively connected to the Internet 1414 via a communication device 1416. Internet 1414 connectivity is well known within the art. In one embodiment, a communication device 1416 is a modem that responds to communication drivers to connect to the Internet via what is known in the art as a “dial-up connection.” In another embodiment, a communication device 1416 is an Ethernet® or similar hardware network card connected to a local-area network (LAN) that itself is connected to the Internet via what is known in the art as a “direct connection” (e.g., T1 line, etc.).

A user enters commands and information into the computer 1402 through input devices such as a keyboard 1418 or a pointing device 1420. The keyboard 1418 permits entry of textual information into computer 1402, as known within the art, and embodiments are not limited to any particular type of keyboard. Pointing device 1420 permits the control of the screen pointer provided by a graphical user interface (GUI) of operating systems such as versions of Microsoft Windows®. Embodiments are not limited to any particular pointing device 1420. Such pointing devices include mice, touch pads, trackballs, remote controls and point sticks. Other input devices (not shown) can include a microphone, joystick, game pad, satellite dish, scanner, or the like.

In some embodiments, computer 1402 is operatively coupled to a display device 1422. Display device 1422 is connected to the system bus 1412. Display device 1422 permits the display of information, including computer, video and other information, for viewing by a user of the computer. Embodiments are not limited to any particular display device 1422. Such display devices include cathode ray tube (CRT) displays (monitors), as well as flat panel displays such as liquid crystal displays (LCD's). In addition to a monitor, computers typically include other peripheral input/output devices such as printers (not shown). Speakers 1424 and 1426 provide audio output of signals. Speakers 1424 and 1426 are also connected to the system bus 1412.

Computer 1402 also includes an operating system (not shown) that is stored on the computer-accessible media RAM 1406, ROM 1408, and mass storage device 1410, and is and executed by the processor 1404. Examples of operating systems include Microsoft Windows®, Apple MacOS®, Linux®, UNIX®. Examples are not limited to any particular operating system, however, and the construction and use of such operating systems are well known within the art.

Embodiments of computer 1402 are not limited to any type of computer 1402. In varying embodiments, computer 1402 comprises a PC-compatible computer, a MacOS®-compatible computer, a Linux®-compatible computer, or a UNIX®-compatible computer. The construction and operation of such computers are well known within the art.

Computer 1402 can be operated using at least one operating system to provide a graphical user interface (GUI) including a user-controllable pointer. Computer 1402 can have at least one web browser application program executing within at least one operating system, to permit users of computer 1402 to access an intranet, extranet or Internet world-wide-web pages as addressed by Universal Resource Locator (URL) addresses. Examples of browser application programs include Netscape Navigator® and Microsoft Internet Explorer®.

The computer 1402 can operate in a networked environment using logical connections to one or more remote computers, such as remote computer 1428. These logical connections are achieved by a communication device coupled to, or a part of, the computer 1402. Embodiments are not limited to a particular type of communications device. The remote computer 1428 can be another computer, a server, a router, a network PC, a client, a peer device or other common network node. The logical connections depicted in FIG. 14 include a local-area network (LAN) 1430 and a wide-area network (WAN) 1432. Such networking environments are commonplace in offices, enterprise-wide computer networks, intranets, extranets and the Internet.

When used in a LAN-networking environment, the computer 1402 and remote computer 1428 are connected to the local network 1430 through network interfaces or adapters 1434, which is one type of communications device 1416. Remote computer 1428 also includes a network device 1436. When used in a conventional WAN-networking environment, the computer 1402 and remote computer 1428 communicate with a WAN 1432 through modems (not shown). The modem, which can be internal or external, is connected to the system bus 1412. In a networked environment, program modules depicted relative to the computer 1402, or portions thereof, can be stored in the remote computer 1428.

Computer 1402 also includes power supply 1438. Each power supply can be a battery.

### Apparatus Embodiments

In the previous section, methods are described. In this section, particular apparatus of such an embodiment are described.

FIG. 15 is a block diagram of an apparatus 1500 to generate reference diagnostic medical images according to an embodiment. Apparatus 1500 solves the need in the art for more consistent, formalized and reliable diagnoses of medical conditions and diseases from medical anatomical images.

In apparatus 1500, four different comparisons can be performed on the image data; a comparison 1502 of raw images, a comparison 1504 of standard deviation images, a comparison 1506 of severity images, and a comparison of severity Scores. The comparison can happen at any of the stages 1502, 1502, 1506 or 1508. Each of the comparisons 1502-1508 are performed across longitudinal (temporal) domains, such as Examination Time T₁ 1510 and Examination Time T₂ 1512.

At Examination Time T₁ 1510 and Examination Time T₂ 1512, a plurality of raw original images 1514 and 1516, 1518 and 1520 respectively are generated by an digital imaging device.

After Examination Time T₁ 1510 and Examination Time T₂ 1512, any one of the following three data are generated from the raw original images and from one or more standardized images (not shown); a plurality of standardized deviation images 1522 and 1524, and 1526 and 1528; severity indices 1530-1536 or severity scores 1538 and 1540. The deviation images 1522-1528 graphically represent the deviation between the raw original images 1514-1520 and the standardized images. The severity indices 1530-1536 numerically represent clinically perceived deviation between the raw original images 1514-1520 and the standardized images. The severity scores 1538 and 1540 are generated from the severity indices 1530-1536. The severity scores 1538 and 1540 numerically represent a composite clinical indication of the condition of the raw images 1514-1520.

### CONCLUSION

A computer-based medical diagnosis system is described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations. For example, although described in procedural terms, one of ordinary skill in the art will appreciate that implementations can be made in a procedural design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application is meant to include all object-oriented, database and communication environments and alternate technologies which provide the same functionality as described herein.

We claim:

1. A method to identify a change in a status of a disease, the method comprising:
accessing at least two longitudinal image data of an anatomical feature, the longitudinal anatomical image data being consistent with an indication of functional information in reference to at least one tracer in the anatomical feature at the time of the imaging; and
determining deviation severity data from each of the longitudinal anatomical image data and from normative standardized anatomical image data based on a criterion of a human;
presenting the deviation severity data for the anatomical feature;
presenting an expected image deviation that is categorized into a degree of severity for each of the anatomical feature;
receiving an indication of a selection of a severity index for each longitudinal dataset; and
generating a combined severity-changes-score from the plurality of severity indices in reference to a rules-based process.

2. The method of claim 1, the method further comprises:
presenting the combined severity-changes-index.

3. The method of claim 1, wherein determining deviation data further comprises:
comparing the anatomical longitudinal image data with normative standardized anatomical image data in reference to the at least one tracer in the anatomical feature at the time of the imaging.

4. The method of claim 1, wherein receiving an indication of the severity index further comprises:
receiving the selected severity index from a graphical user interface, wherein the selected severity index is entered manually into the graphical user interface by a human.

5. The method of claim 1, wherein the generating a combined severity score further comprises:
combining the plurality of severity indices in reference to a rules-based process.

6. The method of claim 1, wherein the anatomical feature further comprises:
one of a brain and a cardiac region.

7. The method of claim 1, wherein the criterion of a human further comprises:
at least one of an age criterion and a sex criterion.

8. The method of claim 1, wherein the longitudinal image data is acquired using one of magnetic resonance imaging, positron emission tomography, computed tomography, single photon emission computed tomography, ultrasound and optical imaging.

9. A method to identify a change in a status of a disease, the method comprising:
receiving an indication of a selection of a severity index for each of a temporal image data of an anatomical feature, the anatomical temporal image data being consistent with an indication of functional information in reference to at least one tracer in the anatomical feature at the time of the imaging; and
generating a combined severity-changes-score from the plurality of severity indices in reference to a rules-based process.

10. The method of claim 9 further comprising:
presenting the combined severity-changes-score.

11. The method of claim 9 further comprising before the receiving action:
accessing the temporal image data of an anatomical feature; and
determining deviation severity data from the anatomical temporal image data and from normative standardized anatomical image data based on the age and sex of a human;
presenting the deviation severity data for each of the anatomical feature; and
presenting an expected image deviation that is categorized into a degree of severity for each of the anatomical feature.

12. The method of claim 11, wherein determining deviation data further comprises:
comparing the anatomical temporal image data with normative standardized anatomical image data in reference to the at least one tracer in the anatomical feature at the time of the imaging.

13. The method of claim 9, wherein receiving an indication of the severity index further comprises:
receiving the selected severity index from a graphical user interface, wherein the selected severity index is entered manually into the graphical user interface by a human.

14. The method of claim 9, wherein the generating a combined severity-changes score further comprises:
combining the plurality of severity indices in reference to a rules-based process.

15. The method of claim 9, wherein the anatomical feature further comprises:
one of a brain and a cardiac region.

16. The method of claim 9, wherein the temporal image data is acquired using one of magnetic resonance imaging, positron emission tomography, computed tomography, single photon emission computed tomography, ultrasound and optical imaging.

17. A method to create formalized representation of conditions and diseases in medical anatomical images, the method comprising:
generating one of a group of comparisons consisting of at least one comparison of standardized deviation anatomical images, that yields deviation images that graphically represent a deviation between the raw original anatomical images and normative standardized images, at least one comparison of severity anatomical indices and at least one comparison of severity scores,
wherein each of the comparisons are performed across temporal domains

18. The method of claim 17 further comprising:
presenting the generated comparison.

19. The method of claim 17 further comprising:
generating a combined severity-change-measure from the comparison.

20. The method of claim 17, wherein the medical anatomical images further comprises:
one of a medical brain image and a medical cardiac region image.
